(19) United States
(12) Patent Application Publication
(10) Pub. No.: US 2013/0050413 A1
(43) Pub. Date: Feb. 28, 2013

(54) VIDEO SIGNAL PROCESSING APPARATUS, VIDEO SIGNAL PROCESSING METHOD, AND COMPUTER PROGRAM

(71) Applicant: Makoto Tsukamoto, Kanagawa (JP)

(72) Inventor: Makoto Tsukamoto, Kanagawa (JP)

(73) Assignee: SONY CORPORATION, Tokyo (JP)

(21) Appl. No.: 13/571,880

(22) Filed: Aug. 10, 2012

(30) Foreign Application Priority Data
Aug. 22, 2011 (JP) 2011-180171

(51) Int. Cl. H04N 13/00

(52) U.S. Cl. 348/42; 348/E13.001

(57) ABSTRACT

A video signal processing apparatus includes: a video input section configured to receive input of a stereoscopic image; a depth calculation section configured to perform depth calculation of the input stereoscopic image; and an edge-and-fineness enhancement processing section configured to perform image quality adjustment with varied strength of edge-and-fineness enhancement of the stereoscopic image on the basis of a result of the depth calculation by the depth calculation section.

### BACKGROUND

The technique disclosed in this specification relates to a video signal processing apparatus, a video signal processing method, and a computer program that performs image quality adjustment of a stereoscopic image including a left-eye video signal and a right-eye video signal. In particular, the technique relates to a video signal processing apparatus, a video signal processing method, and a computer program that achieves enhancement of edges and fineness of a subject included in a stereoscopic image.

By displaying an image having visual disparities between left and right eyes, it is possible to present a three-dimensional image that is viewed in three dimensions to an observer. For example, a time-division three-dimensional image display system includes a combination of a display apparatus that displays a plurality of different images with each other in a time divisional manner, and shutter glasses to be worn by the observer of the image. The display apparatus alternately displays a left-eye image and a right-eye image in a time divisional manner, and the shutter glasses carries out image selection by a shutter mechanism in synchronism with display switching by the display apparatus so that the left-eye image and the right-eye image are fused into a three-dimensional image in a brain of the user who is observing the image.

It is noted that if an amount of visual disparity between a left-eye image and a right-eye image is increased, a stereoscopic effect is increased. For example, a proposal has been made of a method of adjusting a stereoscopic effect in which stereoscopic effect adjustment is made on the basis of visual disparity information PR obtained in the process of generating a 3D video from a 2D video (for example, refer to Japanese Unexamined Patent Application Publication No. 11-239364). However, no proposal has been made of a specific method of detecting visual disparity information PR. That is to say, in the case of performing stereoscopic effect adjustment by detecting visual disparity information (amount of depth) from a 3D video, detection precision of visual disparity information (amount of depth) is low by a general method. Accordingly, it is thought that the obtained visual disparity information (amount of depth) is difficult to be used for stereoscopic effect adjustment.

Also, a proposal has been made of a video signal processing apparatus in which depth direction (Z-axis direction) information is detected from a 3D video, and image-quality improvement processing is performed on the basis of the depth direction (Z-axis direction) information (for example, refer to Japanese Unexamined Patent Application Publication No. 2011-19202). However, there has been a problem in that in a video whose depth direction (Z-axis direction) is different to detect, if image-quality improvement processing is performed on the basis of the erroneously detected depth direction (Z-axis direction) information, the image quality becomes unnatural.

### SUMMARY

It is desirable to provide an excellent video signal processing apparatus, a video signal processing method, and a computer program which is capable of suitably performing image quality adjustment of a stereoscopic image including a left-eye video signal and a right-eye video signal.

According to an embodiment of the present disclosure, there is provided a video signal processing apparatus including: a video input section configured to receive input of a stereoscopic image; a depth calculation section configured to perform depth calculation of the input stereoscopic image; and an edge-and-fineness enhancement processing section configured to perform image quality adjustment with varied strength of edge-and-fineness enhancement of the stereoscopic image on the basis of a result of the depth calculation by the depth calculation section.

In the above-described embodiment of the present disclosure, the edge-and-fineness enhancement processing section may determine the strength of the edge-and-fineness enhancement on the basis of a focus position determined from the result of the depth calculation by the depth calculation section.

In the above-described embodiment of the present disclosure, if a near-view portion of the stereoscopic image is determined to be in focus as the result of the depth calculation by the depth calculation section, the edge-and-fineness enhancement processing section may increase the strength of the edge-and-fineness enhancement, else if a distant-view portion of the stereoscopic image is determined to be in focus as the result of the depth calculation, the edge-and-fineness enhancement processing section may decrease the strength of the edge-and-fineness enhancement, and if the stereoscopic image is determined to have a deep depth of field as the result of the depth calculation, the edge-and-fineness enhancement processing section slightly may decrease the strength of the edge-and-fineness enhancement.

In the above-described embodiment of the present disclosure, if a difference in amount of depth between a near view and a distant view of the stereoscopic image is determined to be large as the result of the depth calculation by the depth calculation section, the edge-and-fineness enhancement processing section may increase the strength of the edge-and-fineness enhancement, and if a difference in amount of depth between a near view and a distant view of the stereoscopic image is determined to be small as the result of the depth calculation, the edge-and-fineness enhancement processing section may decrease the strength of the edge-and-fineness enhancement.

In the above-described embodiment of the present disclosure, the edge-and-fineness enhancement processing section may perform the edge-and-fineness enhancement with uniform strength on an overall image of one frame.

In the above-described embodiment of the present disclosure, the video input section may receive input of the stereoscopic image in a method of multiplexing simultaneous left-eye image and right-eye image in a time direction, and the depth calculation section may extract a feature quantity from a left-eye image, then may extract a feature quantity from a simultaneous right-eye image, and may compare the feature quantity of the left-eye image and the feature quantity of the right-eye image so as to calculate a depth of the stereoscopic image.

In the above-described embodiment of the present disclosure, the depth calculation section may perform band-pass filter processing with a predetermined number of taps on the left-eye image in the vertical direction and in the horizontal direction individually, may obtain a feature quantity of each pixel position on the basis of a product of a band-pass component in the vertical direction and a band-pass component in the horizontal direction, may detect a pixel position having a maximum feature quantity in each block as a feature point, may store a feature quantity of the feature point of each block, may calculate a same feature quantity as described above at all the pixel positions of each block of the right-eye image, may compare the calculated feature quantity with the feature quantity stored at the feature point of the corresponding block to the left-eye image, may detect a pixel position of the right-eye image matching the feature point of the left-eye image for each block, and may store an amount of depth and a band component at a pixel position of the right-eye image matching the feature point of the left-eye image for each block.

In the above-described embodiment of the present disclosure, the depth calculation section may store, for a feature point of each block of the left-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block, and an x-coordinate of the feature point in the block as feature-point data, may calculate, at all the pixel positions of each block of the right-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block as feature-point data, may take a weighted sum of absolute difference between the feature-point data at each pixel position and the feature-point data at the corresponding feature point of the left-eye image as an evaluation value of each pixel position, may obtain a pixel position having a minimum evaluation value in each block of the right-eye image as a pixel position matching the feature point of the left-eye image, and may store an amount of depth and a band component at the pixel position of the right-eye image matching the feature point of the left-eye image in each block.

In the above-described embodiment of the present disclosure, the depth calculation section may classify each block into a near view and a distant view on the basis of the amount of depth, may average amounts of depth and band components of blocks in the near view, and may average amounts of depth and band components of blocks in the distant view.

In the above-described embodiment of the present disclosure, the depth calculation section may obtain a difference between the amounts of depth of the near view and the distant view of the stereoscopic image by calculating a difference between the mean value of the amounts of depth in the near view block and the mean value of the amounts of depth in the distant view block, if the difference between the amounts of depth of the near view and the distant view of the stereoscopic image is large, a weight for the strength of the edge-and-fineness enhancement may be increased, and if the difference between the amounts of depth of the near view and the distant view of the stereoscopic image is small, a weight for the strength of the edge-and-fineness enhancement may be decreased.

In the above-described embodiment of the present disclosure, the depth calculation section may obtain a difference between band components of the near view and the distant view of the stereoscopic image by calculating a difference between the mean value of the band components in the near view block and the mean value of the band components in the distant view block, if the difference between the band components of the near view and the distant view of the stereoscopic image is large, a weight for the strength of the edge-and-fineness enhancement may be increased, and if the difference between the band components of the near view and the distant view of the stereoscopic image is small, a weight for the strength of the edge-and-fineness enhancement may be decreased.

In the above-described embodiment of the present disclosure, the depth calculation section may combine a weight given on the basis of the averaged amount of depth and a weight given on the basis of the averaged band component, and then may perform low-pass filter processing to obtain the strength of the edge-and-fineness enhancement.

In the above-described embodiment of the present disclosure, the video signal processing apparatus may further include an interframe movement detection section configured to detect interframe movement of the input image, wherein if the interframe movement is large, the depth calculation section may perform the low-pass filter processing with a filter coefficient having a small time constant, and if the interframe movement is small, the depth calculation section may perform the low-pass filter processing with a filter coefficient having a large time constant.

In the above-described embodiment of the present disclosure, a block size of the left-eye image may be made smaller than a block size of the left-eye image.

According to another embodiment of the present disclosure, there is provided a method of processing a video signal, including: receiving input of a stereoscopic image; performing depth calculation of the input stereoscopic image; and processing edge-and-fineness enhancement to perform image quality adjustment with varied strength of the edge-and-fineness enhancement of the stereoscopic image on the basis of a result of the depth calculation by the performing depth calculation.

According to another embodiment of the present disclosure, there is provided a computer program, described in a computer-readable format, for causing a computer to perform functions including: a video input section configured to receive input of a stereoscopic image; a depth calculation section configured to perform depth calculation of the input stereoscopic image; and an edge-and-fineness enhancement processing section configured to perform image quality adjustment with varied strength of edge-and-fineness enhancement of the stereoscopic image on the basis of a result of the depth calculation by the depth calculation section.

In the above-described embodiment of the present disclosure, the computer program is a computer program that is described in a computer-readable format so as to achieve predetermined processing on a computer. To put it another way, the computer program according to the embodiment of the present disclosure may be installed into a computer so that cooperative operation is achieved on the computer, and a same working effect as that of the video signal processing apparatus described above can be obtained.

By the technique disclosed in this specification, it is possible to provide an excellent video signal processing apparatus, a video signal processing method, and a computer program which is capable of suitably adjusting strength of edge-and-fineness enhancement of a subject included in a stereoscopic image in accordance with a result of depth calculation of the stereoscopic image.

By the technique disclosed in this specification, strength of edge-and-fineness enhancement is not changed individually for each of a near view portion and a distant view portion that are included in one frame of video. And the edge-and-fineness enhancement is performed on the entire one-frame image with uniform strength. Accordingly, even if there is erroneous detection in depth calculation, there is an advantage in that unnatural image quality is unlikely to be produced.

By the technique disclosed in this specification, it is possible to perform edge-and-fineness enhancement on a stereoscopic image in a natural manner.

By the technique disclosed in this specification, it is possible to calculate an amount of depth of a stereoscopic image with a small-sized circuit configuration, and it is not necessary to use a frame memory at the time of the calculation.

The other objects, features and advantages of the technique disclosed in this specification will become apparent by a more detailed description based on the embodiment described later and the accompanying drawings.

### BRIEF DESCRIPTION OF THE DRAWINGS

FIG. 1 is a diagram schematically illustrating a configuration of a video signal processing apparatus according to a technique disclosed in this specification;

FIG. 2A is a diagram generally illustrating processing that is performed by an edge-and-fineness enhancement processing section on the basis of a result of depth calculation;

FIG. 2B is a diagram generally illustrating processing that is performed by an edge-and-fineness enhancement processing section on the basis of a result of depth calculation;

FIG. 3 is a diagram illustrating a functional configuration for processing a left-eye image in a depth calculation section;

FIG. 4 is a diagram for explaining processing performed by a feature-quantity calculation section;

FIG. 5 is a diagram illustrating an example of a frequency characteristic of a band-pass filter used for extracting a feature quantity from a video;

FIG. 6 is a diagram illustrating a state of setting a plurality of blocks in a left-eye image;

FIG. 7 is a diagram illustrating feature point data to be stored for feature points of individual blocks of a left-eye image in order to match a right-eye image;

FIG. 8 is a diagram illustrating a functional configuration for processing a simultaneous right-eye image with a left-eye image in the depth calculation section;

FIG. 9A is a diagram individually illustrating block positions of a left-eye image and block positions of a right-eye image;

FIG. 9B is a diagram in which corresponding blocks between the left-eye image and the right-eye image are drawn in an overlapping manner;

FIG. 10 is a diagram illustrating a feature point in a left-eye image block and a corresponding pixel position in a right-eye image block for individual cases of a near view and a distant view;

FIG. 11 is a diagram illustrating an example of a functional configuration for extracting band components of a right-eye image;

FIG. 12 is a diagram illustrating an example of a functional configuration for performing statistical processing of amounts of depth in the depth calculation section;

FIG. 13 is a diagram illustrating an example of blocks included in an image;

FIG. 14 is a diagram illustrating an example of a weight of edge-and-fineness enhancement that is given in accordance with a difference of amounts of depth between a near view and a distant view;

FIG. 15 is a diagram illustrating an example of a weight of edge-and-fineness enhancement that is given in accordance with a difference between band components of a near view and a distant view;

FIG. 16 is a diagram illustrating an example of a configuration for performing low-pass filter processing on strength of edge-and-fineness enhancement for each of band-pass components and high-pass components in the time axis direction;

FIG. 17 is a diagram illustrating an example of a functional configuration for detecting interframe movement; and

FIG. 18 is a diagram illustrating an example of an internal configuration of the edge-and-fineness enhancement processing section.

### DETAILED DESCRIPTION OF EMBODIMENT

In the following, a detailed description will be given of an embodiment of a technique disclosed in this specification with reference to the drawings.

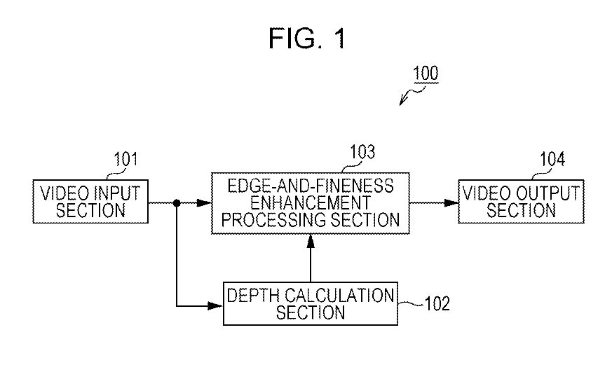

FIG. 1 schematically illustrates a configuration of a video signal processing apparatus 100 according to the technique disclosed in this specification. The video signal processing apparatus 100, illustrated in FIG. 1, includes a video input section 101, which receives input of a stereoscopic image, a depth calculation section 102, which calculates depth of the input stereoscopic image, an edge-and-fineness enhancement processing section 103, which adjusts strength of edge-and-fineness enhancement of the stereoscopic image on the basis of a result of the depth calculation, and a video output section 104, which outputs the stereoscopic image after performing edge-and-fineness enhancement processing.

The stereoscopic image inputted into the video input section 101 is, for example, a video of a frame packing method. The frame packing is a transmission format of a stereoscopic image signal in which two-frame images, simultaneous left-eye and right-eye images, are included in one vertical blanking period.

The depth calculation section 102 performs depth calculation of the stereoscopic image. As a result of calculation by the depth calculation section 102, information is individually obtained on amounts of depth of a near view portion and a distant view portion included in the image, and which part of the near view portion and the distant view portion is brought into focus, etc. Thereby, strength of the edge-and-fineness enhancement is obtained in accordance with the depth.

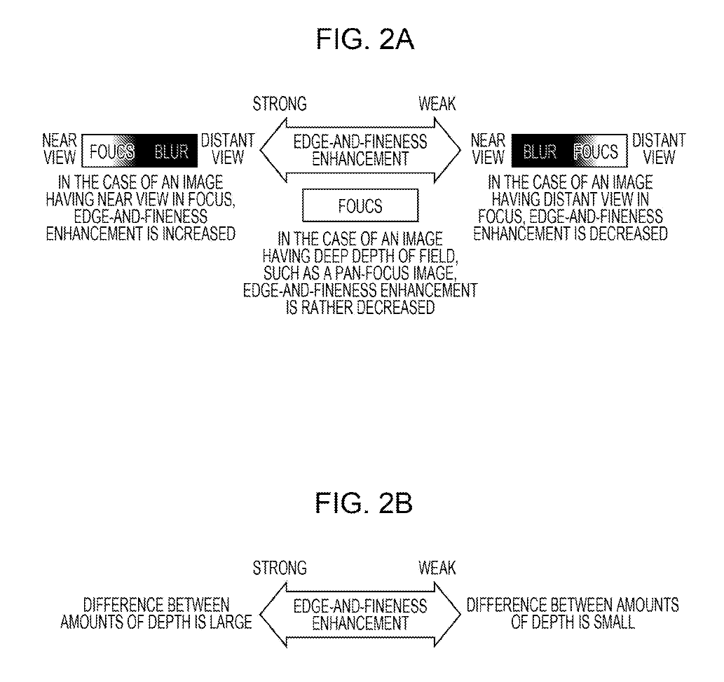

The edge-and-fineness enhancement processing section 103 changes the strength of the edge-and-fineness enhancement of the stereoscopic image on the basis of the result of the depth calculation by the depth calculation section 102, and performs image quality adjustment on the input stereoscopic image. FIG. 2A and FIG. 2B generally illustrate processing that is performed by the edge-and-fineness enhancement processing section 103 on the basis of the result of the depth calculation.

As a result of the depth calculation by the depth calculation section 102, if it is determined that the near view portion is in focus, the edge-and-fineness enhancement processing section 103 increases strength of the edge-and-fineness enhancement. On the contrary, if it is determined that the distant view portion is in focus, the edge-and-fineness enhancement processing section 103 decreases the strength of the edge-and-fineness enhancement. Also, as in the case of pan-focus, if a depth of field is deep, the edge-and-fineness enhancement processing section 103 slightly decreases the strength of the edge-and-fineness enhancement (refer to FIG. 2A).

Also, if a difference in amount of depth between a near view and a distant view of an input image is large from a result of the depth calculation, the depth calculation section 102 increase the strength of the edge-and-fineness enhancement applied in the edge-and-fineness enhancement processing section 103. On the contrary, if a difference in amount of depth between a near view and a distant view of an input image is small, the depth calculation section 102 decreases the strength of the edge-and-fineness enhancement applied in the edge-and-fineness enhancement processing section 103 (refer to FIG. 2B).

Finally, final strength of the edge-and-fineness enhancement that is applied in the edge-and-fineness enhancement processing section 103 is determined by a product of the strength of the edge-and-fineness enhancement on the basis of the focus position, and the strength of the edge-and-fineness enhancement on the basis of the amount of depth.

In this regard, the edge-and-fineness enhancement processing section 103 does not change the strength of the edge-and-fineness enhancement individually for the near view portion and the distant view portion that are included in one-frame image. The edge-and-fineness enhancement processing section 103 performs the edge-and-fineness enhancement on the entire one-frame image with uniform strength. Accordingly, even if there is erroneous detection in depth calculation, there is an advantage in that unnatural image quality is unlikely to be produced.

As described above, the video input section 101 receives input of a stereoscopic image in the frame packing method. That is to say, the video input section 101 receives in the order of simultaneous left-eye and right-eye images. Accordingly, the depth calculation section 102 extracts a feature quantity from the left-eye image that is input first. Next, the depth calculation section 102 extracts a feature quantity from the simultaneous right-eye image that is input subsequently. And a comparison is made between the feature quantity of the left-eye image and the feature quantity of the right-eye image so as to detect information on depth of the image.

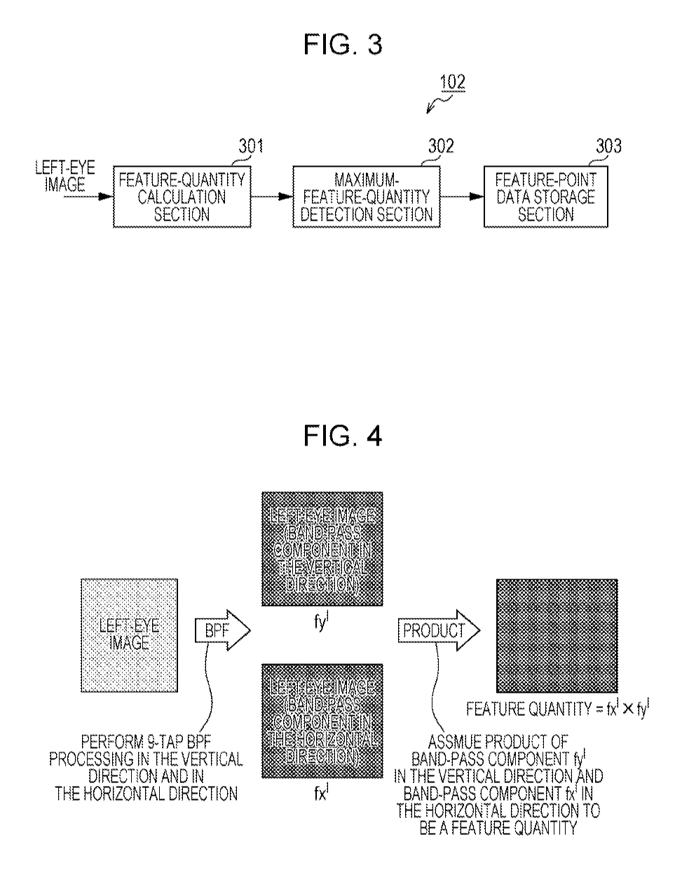

FIG. 3 illustrates a functional configuration for processing a left-eye image in the depth calculation section 102. In an example illustrated in FIG. 3, the depth calculation section 102 includes a feature-quantity calculation section 301, a maximum-feature-quantity detection section 302, and a feature-point storage section 303 in order to process the left-eye image.

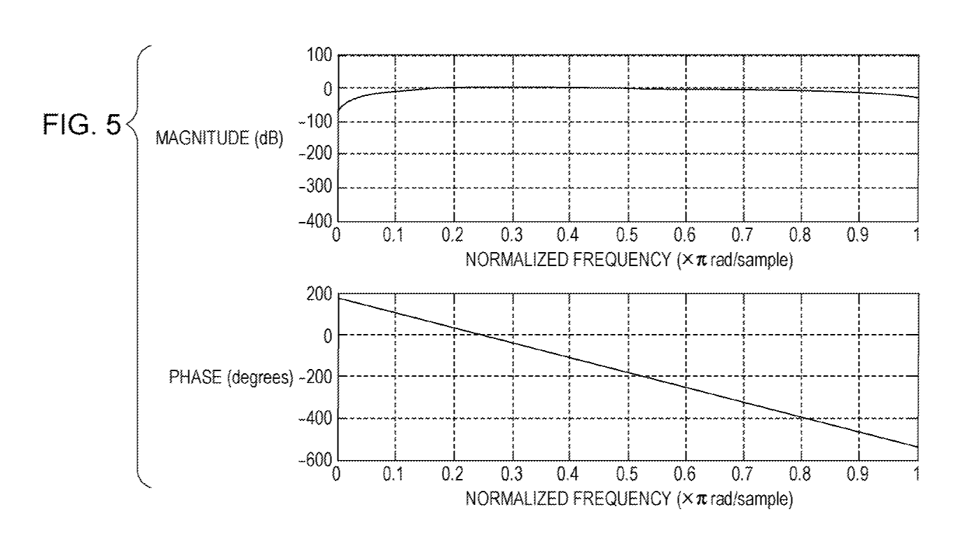

FIG. 4 illustrates processing performed by the feature-quantity calculation section 301. The feature-quantity calculation section 301 performs nine-tap band-pass filter (BPF) processing on the input left-eye image in the vertical direction and in the horizontal direction, respectively. Here, an example of a frequency characteristic of the band-pass filter for use in extracting a feature quantity from a video is illustrated in FIG. 5. Here, it is assumed that a band-pass component in the horizontal direction is fx¹, and a band-pass component in the vertical direction is fy¹. And the feature-quantity calculation section 301 calculates a product of the band-pass component fx¹ in the horizontal direction and the band-pass component fy¹ in the vertical direction for each pixel, and determines a calculation result fx¹×fy¹ for each pixel to be a feature quantity of each pixel.

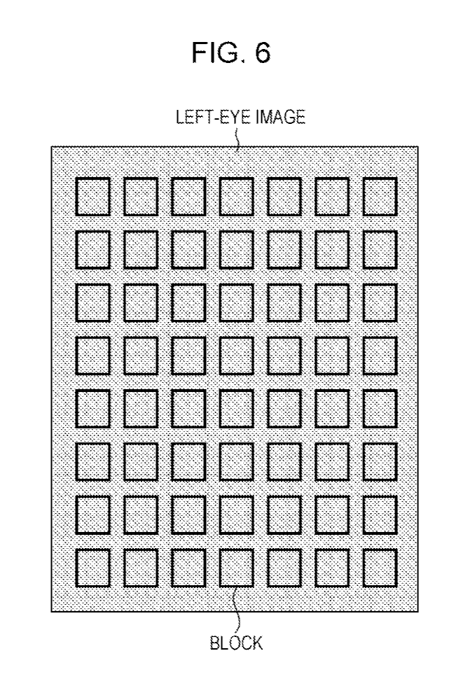

Next, as illustrated in FIG. 6, when a plurality of blocks are set in the input left-eye image, the maximum-feature-quantity detection section 302 detects a pixel position having a maximum feature quantity fx¹×fy¹ in each of the blocks.

The pixel position having the maximum feature quantity fx¹×fy¹ in each block is handled as a feature point of the block. An edge, etc., tends to be a feature point. A band-pass filter is used in the calculation of the feature quantity, and thus noise is difficult to become a feature point.

And the feature-point storage section 303 stores the feature quantity at the feature point of each block as matching data with a simultaneous right-eye image, namely, feature point data.

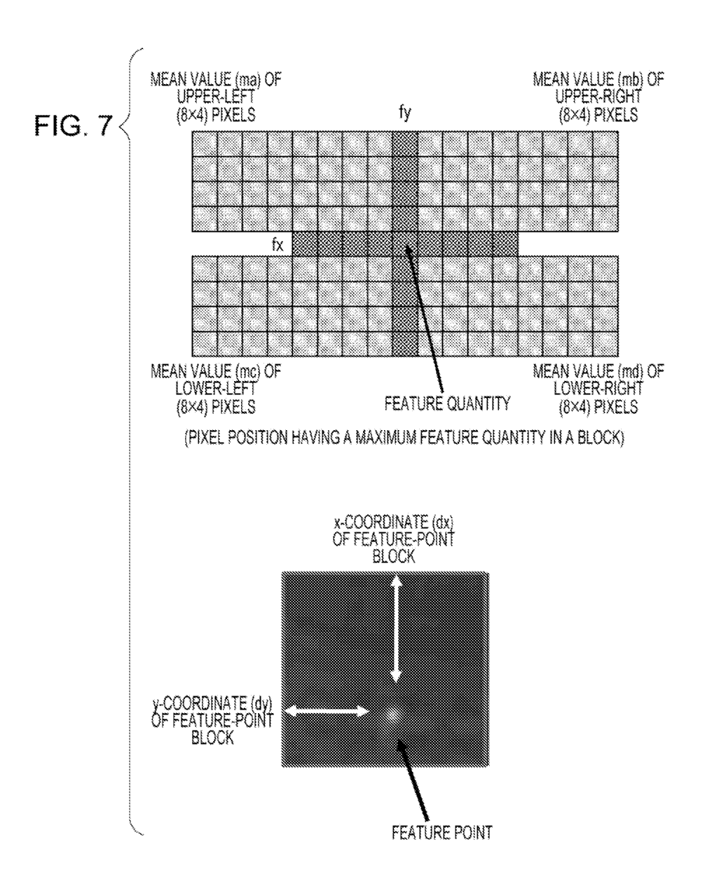

The feature-point storage section 303 stores eight pieces of feature point data illustrated below, for example, for matching with the right-eye image with respect to a feature point of each block of the left-eye image. FIG. 7 illustrates these feature point data.

(1) Band-pass component (fy¹) in the vertical direction

(2) Band-pass component (fx¹) in the horizontal direction

(3) Mean value (ma¹) of upper-left (8×4) pixels

(4) Mean value (mb¹) of upper-right (8×4) pixels

(5) Mean value (mc¹) of lower-left (8×4) pixels

(6) Mean value (md¹) of lower-right (8×4) pixels

(7) y-coordinate (dy¹) in a block of a feature point

(8) x-coordinate (dx¹) in a block of a feature point

A frame memory is not necessary for processing to store feature point data with respect to the left-eye image as illustrated in FIG. 3. An eight-line memory and a memory for storing feature point data ought to be provided.

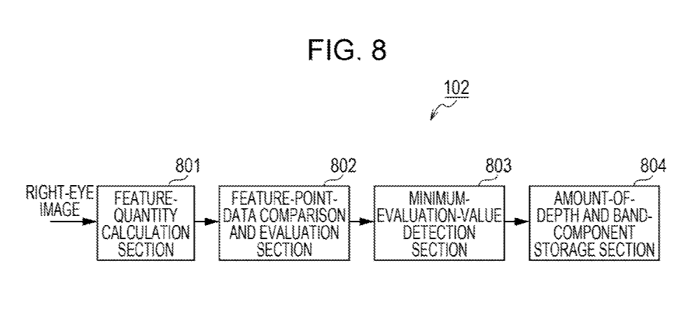

Also, FIG. 8 illustrates a functional configuration for processing the simultaneous right-eye image with the left-eye image in the depth calculation section 102. In an example in FIG. 8, for right-eye image processing, the depth calculation section 102 includes a feature-quantity calculation section 801, a feature-point-data comparison and evaluation section 802, a minimum-evaluation-value detection section 803, and an amount-of-depth and band-component storage section 804.

The feature-quantity calculation section 801 scans all the pixel positions of each block, and calculates the following seven pieces of feature point data at each pixel position.

(1) Band-pass component (fy^{r}) in the vertical direction

(2) Band-pass component (fx^{r}) in the horizontal direction

(3) Mean value (ma^{r}) of upper-left (8×4) pixels

(4) Mean value (mb^{r}) of upper-right (8×4) pixels

(5) Mean value (mc^{r}) of lower-left (8×4) pixels

(6) Mean value (md^{r}) of lower-right (8×4) pixels

(7) y-coordinate (dy^{r}) in a block of a feature point

The feature-point-data comparison and evaluation section 802 compares and evaluates feature point data in each pixel position in each block of the right-eye image with the feature point data stored for the feature point of the corresponding block of the left-eye image. Specifically, as illustrated by the following expression (1), the feature-point-data comparison and evaluation section 802 calculates a weighted sum absolute difference between the feature point data at each pixel position in each block of the right-eye image and the feature point data at the feature point of the corresponding block of the left-eye image, and determines a calculation result to be an evaluation value of each pixel position of the right-eye image.

Evaluation value=(|fx¹−fx^{r}|+|fy¹−fy^{r}|)×2+(|ma¹−ma^{r}|+|mb¹−mb^{r}+|mc¹−mc^{r}+|md¹−|md^{r}|)+|dy¹−dy^{r}|×4 (1)

Performing matching on a featureless flat portion, etc., becomes difficult image processing. Thus, it is apprehended that precision of depth detection decreases in a featureless image portion. On the other hand, in the technique disclosed in this specification, the feature-point-data comparison and evaluation section 802 performs stereo matching as described above only on the feature points, and thus high precision of depth detection is obtained.

The minimum-evaluation-value detection section 803 detects a pixel position having a minimum evaluation value, which is obtained as described above, in each block of the right-eye image as a pixel position matching the feature point of the corresponding block of the left-eye image.

An amount of depth of the stereoscopic image is an amount of visual disparity, namely, a difference between the x-coordinate (dx¹) of the feature point of the left-eye image and the x-coordinate (dx^{r}) of the pixel position of the right-eye image that matches this feature point. The amount-of-depth and band-component storage section 804 stores an amount of depth and a band component at the pixel position detected as a minimum evaluation value in each block of the right-eye image.

However, even if the pixel position detected on the basis of the evaluation value is determined to match the feature point of the left-eye image most in a block, there is a possibility that the images do not match on the whole. Thus, if the minimum evaluation value detected in the block is a threshold value or more (there is no pixel position that sufficiently match the feature point in the block of the left-eye image in the block of the right-eye image), or if the feature quantity of the right-eye image is a threshold value or less (there is no feature, and the block is originally unsuitable for matching), the amount of depth and the band component that are obtained from the block are determined not to be used.

In practice, when the minimum evaluation value detected in the block of the right-eye image is a threshold value or less, and if the feature quantity of the right-eye image is a threshold value or more, a validity flag indicating that the obtained data (the amount of depth and the band component) is valid is set for that block. The amount of depth and the band component stored for the block whose validity flag is set is to be used for the subsequent-stage edge-and-fineness enhancement processing. On the contrary, if the validity flag is not set, the amount of depth and the band component that are stored for the block are not used.

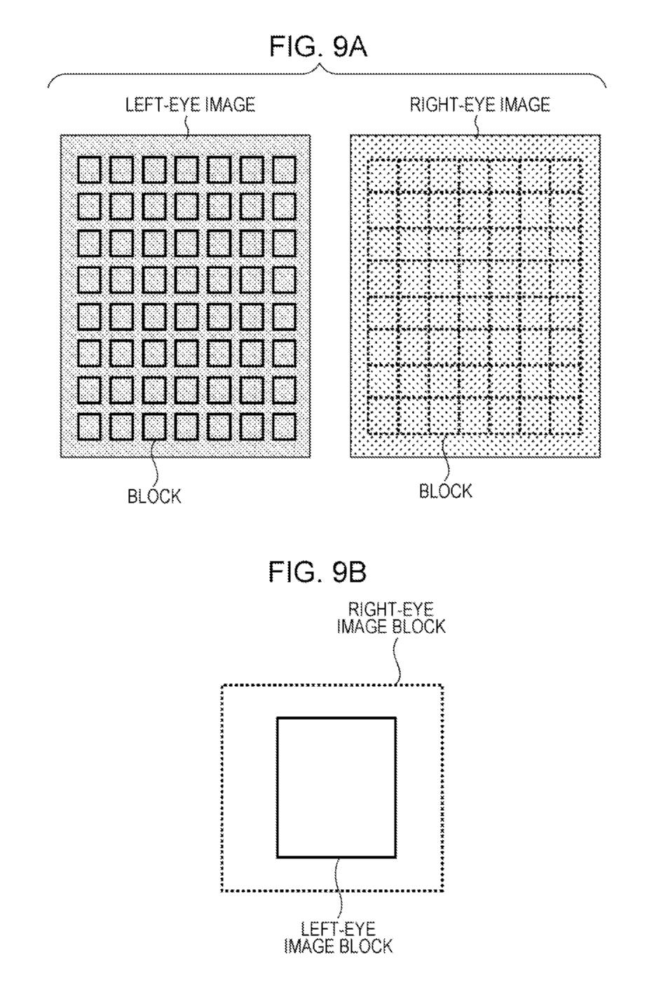

In this regard, FIG. 9A individually illustrates block positions of a left-eye image, and block positions of a right-eye image. Also, in FIG. 9B, corresponding blocks between the left-eye image and the right-eye image are drawn in an overlapping manner. As described above, first, a feature point is extracted from the block of the left-eye image, and then a pixel position that most matches that feature point is searched in the corresponding block of the right-eye image. As illustrated in FIG. 9B, a block of the left-eye image is small in size, and is placed inside the block of the right-eye image, and thus it is not necessary to search a pixel position over the block at the time of searching a pixel position having a matched feature point. In this regard, a margin of each of the left and right end portions of the block of the right-eye image with respect to the corresponding block of the left-eye image is set to a maximum amount of visual disparity of the stereoscopic image or more. Also, a margin of each of the upper and lower end portions is set in consideration of misalignment of a camera position at the time of capturing the stereoscopic image.

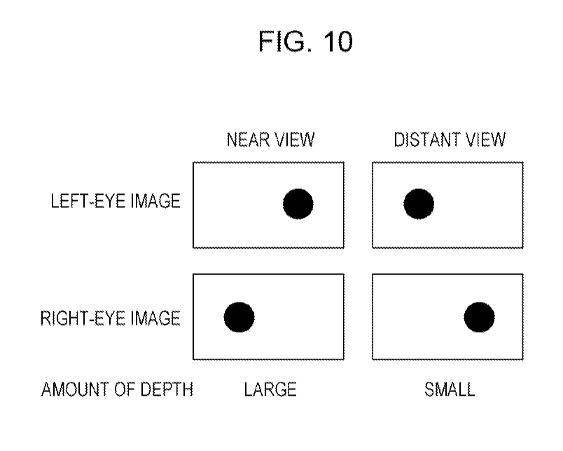

An amount of depth of a stereoscopic image is an amount of visual disparity, that is to say, a difference between an x-coordinate (dx¹) of the feature point of a left-eye image and an x-coordinate (dx^{r}) of a pixel position of a right-eye image matching that feature point. FIG. 10 illustrates a feature point in a left-eye image block and a corresponding pixel position in a right-eye image block for each of the cases of a near view and a distant view, respectively. As is understood from FIG. 10, an amount of depth dx¹-dx^{r} becomes large in the near view, and the amount of depth dx¹-dx^{r} becomes small in the distant view. The amount-of-depth and band-component storage section 804 calculates and stores the amount of depth for each block. As described later, information on the amount of depth and the band component is separated into a near view and a distant view by statistical processing.

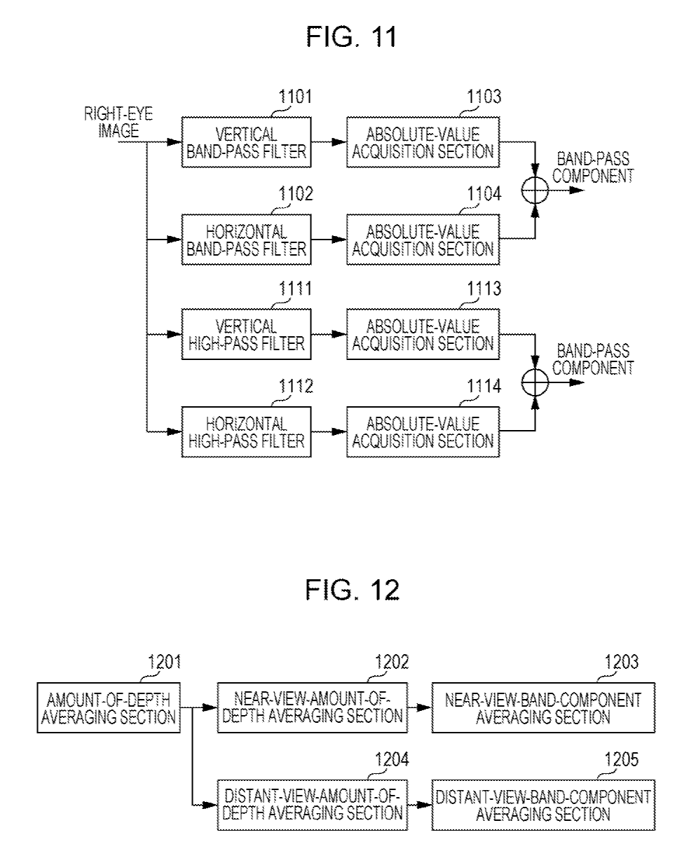

Also, FIG. 11 illustrates an example of a functional configuration for extracting a band component of a right-eye image in the amount-of-depth and band-component storage section 804.

The vertical band-pass filter 1101 receives input of a right-eye image, and performs band-pass filter processing in the vertical direction. Also, the horizontal band-pass filter 1102 receives input of the right-eye image, and performs band-pass filter processing in the horizontal direction. And absolute-value acquisition sections 1103 and 1104 calculate an absolute value of band-pass components in the vertical direction, and an absolute value of band-pass components in the horizontal direction, respectively. These absolute values are added, and thus it is possible to obtain a band-pass component (middle-frequency component) of the right-eye image.

On the other hand, the vertical high-pass filter 1111 receives input of the right-eye image, and performs high-pass filter processing in the vertical direction. Also, the horizontal band-pass filter 1112 receives input of the right-eye image, and performs high-pass filter processing in the horizontal direction. And absolute-value acquisition sections 1113 and 1114 calculate an absolute value of high-pass components in the vertical direction, and an absolute value of high-pass components in the horizontal direction, respectively. These absolute values are added, and thus it is possible to obtain a high-pass component (high-frequency component) of the right-eye image.

The amount-of-depth and band-component storage section 804 stores the band-pass component and the high-pass component that are extracted as described above at the pixel position having a minimum evaluation value in each block of the right-eye image, that is to say, the pixel position matching a feature point of the corresponding block of the left-eye image. However, the band components may be averaged for each block and stored.

In this regard, the filters, illustrated in FIG. 11, which are used in the amount-of-depth and band-component storage section 804 are different from the filters used for calculating the feature quantity, but may be common with the filters used for the edge-and-fineness enhancement processing.

FIG. 12 illustrates an example of a functional configuration for performing statistical processing of the amount of depth and the band component, which are stored as described above, by the depth calculation section 102. In the example illustrated in FIG. 12, the depth calculation section 102 includes a amount-of-depth averaging section 1201, a near-view-amount-of-depth averaging section 1202, a near-view-band-component averaging section 1203, a distant-view-amount-of-depth averaging section 1204, and a distant-view-band-component averaging section 1205.

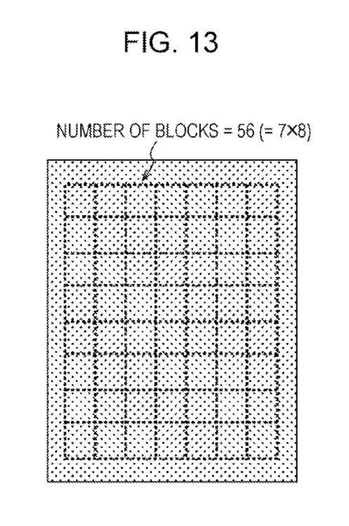

For example, as illustrated in FIG. 13, if the image (right-eye image) includes 7×8=56 blocks, by the above-described calculation of the amount of depth, 56 amounts of depth are obtained for each one frame, and are stored. The amount-of-depth averaging section 1201 averages the amounts of depth of the blocks whose validity flag are set (that is to say, blocks whose minimum evaluation value is a threshold value or less, and in which the feature quantity of the right-eye image is a threshold value or more).

The near-view-amount-of-depth averaging section 1202 determines an amount of depth that is larger than the average amount of depth calculated by the amount-of-depth averaging section 1201 to be an amount of depth of a near view, and averages these amounts of depth. Note that only the blocks whose validity flag is set are to be processed.

The near-view-band-component averaging section 1203 averages band components of feature points having amounts of depth of near views. Note that only the blocks (feature points) whose validity flag is set are to be processed.

The distant-view-amount-of-depth averaging section 1204 averages amounts of depth that are smaller than the average amount of depth calculated by the amount-of-depth averaging section 1201 as a amount of depth of a distant view. Note that only the blocks whose validity flag is set are to be processed.

The distant view band component averaging section 1205 averages band components of feature points having amounts of depth of distant views. Note that only the blocks (feature points) whose validity flag is set are to be processed.

In this regard, as described with reference to FIG. 11, the band components that are stored for each block include two band components, band-pass components and high-pass components. Accordingly, the near-view-band-component averaging section 1203 and the distant view band component averaging section 1205 perform averaging processing of the band-pass components and the high-pass components, respectively.

It is possible to obtain a difference in amount of depth between a near view and a distant view of an input image by subtracting a mean value of the amounts of depth of the near view, which is output from the near-view-amount-of-depth averaging section 1202, from a mean value of the amounts of depth of the distant view, which is output from the distant-view-amount-of-depth averaging section 1204. FIG. 14 illustrates an example of a weight of an edge-and-fineness enhancement that is given in accordance with a difference of amounts of depth between a near view and a distant view. As illustrated in FIG. 14, when the difference in amount of depth is large, a large weight is given so that, as illustrated in FIG. 2B, if the difference in amount of depth between the near view and the distant view of the input image is large, the strength of the edge-and-fineness enhancement is increased. On the contrary, if the difference in amount of depth between the near view and the distant view of the input image is small, the strength of the edge-and-fineness enhancement is decreased, and thus the edge-and-fineness enhancement processing is achieved. Either the depth calculation section 102 or the edge-and-fineness enhancement processing section 103 may give a weight in accordance with the difference in the amount of depth.

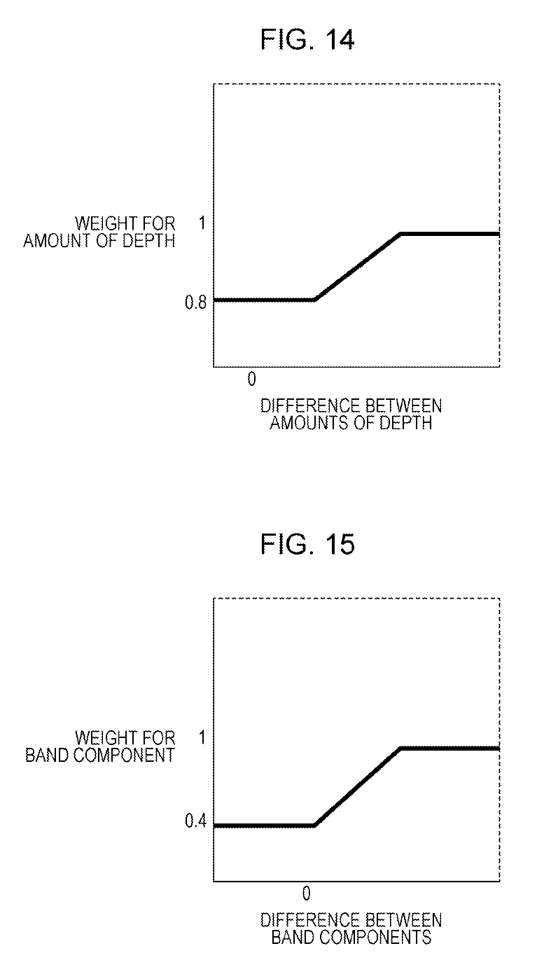

Also, it is possible to determine whether a near view portion of the input image or a distant view portion is in focus by subtracting a mean value of the band components of the near view, which is output from the near-view-band-component averaging section 1203, from a mean value of the band components of the distant view, which is output from the distant-view-band-component averaging section 1205 and obtaining a difference in the band components. It is possible to state that when a difference in the band components is large, the near view portion is in focus, and when a difference in the band components is small, the distant view portion is in focus. FIG. 15 illustrates an example of a weight of an edge-and-fineness enhancement that is given in accordance with a difference in band component between a near view and a distant view. As illustrated in FIG. 15, when a difference in band components is large, a greater weight is given so that, as illustrated in FIG. 2A, if the near view portion is in focus, the strength of the edge-and-fineness enhancement is increased. On the contrary, when the distant view portion is in focus, the strength of the edge-and-fineness enhancement is decreased. Also, in the case of an image having a deep depth of field just like pan-focus, the edge-and-fineness enhancement processing with a slightly low strength of the edge-and-fineness enhancement is achieved. Either the depth calculation section 102 or the edge-and-fineness enhancement processing section 103 may give a weight in accordance with the difference in the band components.

In this regard, the band components include two band components, a band-pass component and a high-pass component, and thus the above-described weight in accordance with a difference in the band components is provided for each band component.

The weight for the amount of depth, obtained as illustrated in FIG. 14, and the weight for the band component, obtained as illustrated in FIG. 15, are mixed so that the strength of the edge-and-fineness enhancement can be obtained. The strength of the edge-and-fineness enhancement is obtained for each component of the band-pass components and the high-pass components. Also, in order to prevent the strength of the edge-and-fineness enhancement from changing drastically, low-pass filter processing is performed on the strength of the edge-and-fineness enhancement in the time axis direction.

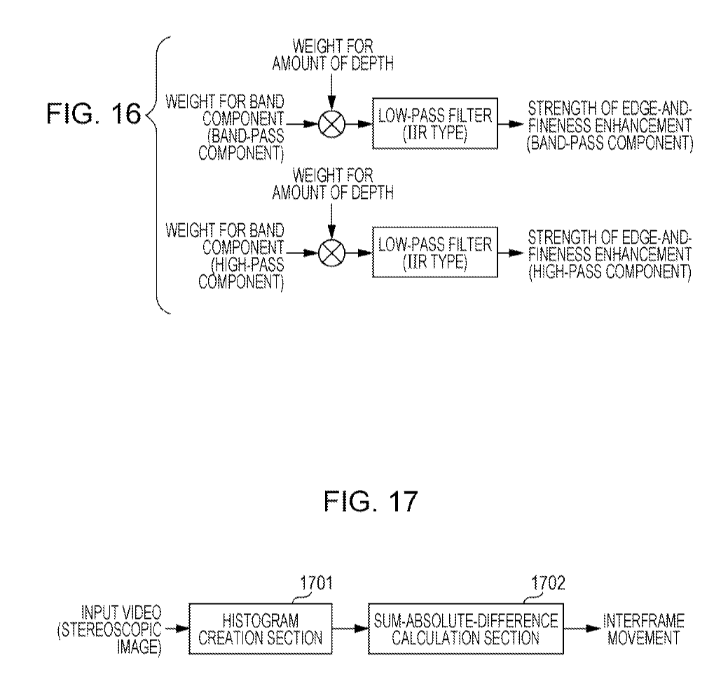

FIG. 16 illustrates an example of a configuration for performing low-pass filter processing on the strength of the edge-and-fineness enhancement for each of the band-pass components and the high-pass components in the time axis direction. For example, it is possible to apply an IIR (Infinite Impulse Response)-type low-pass filter.

Note that a filter coefficient of each low-pass filter is changed in accordance with interframe movement. An example of a functional configuration for detecting interframe movement is illustrated in FIG. 17. A histogram creation section 1701 creates a number-of-pixel distribution histogram of luminance for each frame of an input image. A sum-absolute-difference calculation section 1702 calculates a sum absolute difference between a histogram created for a previous frame and a histogram for a current frame. It is possible to make a determination of interframe movement on the basis of the sum absolute difference.

For example, in a fast moving scene, interframe movement becomes large. In such a case, a filter coefficient having a small time constant is used so that the strength of the edge-and-fineness enhancement is changed sharply. In this case, movement of the scene is fast, and thus it becomes natural even if the strength of the edge-and-fineness enhancement is changed sharply.

On the other hand, when movement of the scene is slow, interframe movement becomes small. In such a case, a filter coefficient having a large time constant is used so that the strength of the edge-and-fineness enhancement is not changed sharply. This is because even if erroneous detection occurs in depth calculation, as long as it is instantaneous error detection, a result of erroneous detection becomes difficult to be reflected on the edge-and-fineness enhancement by the low-pass filter processing.

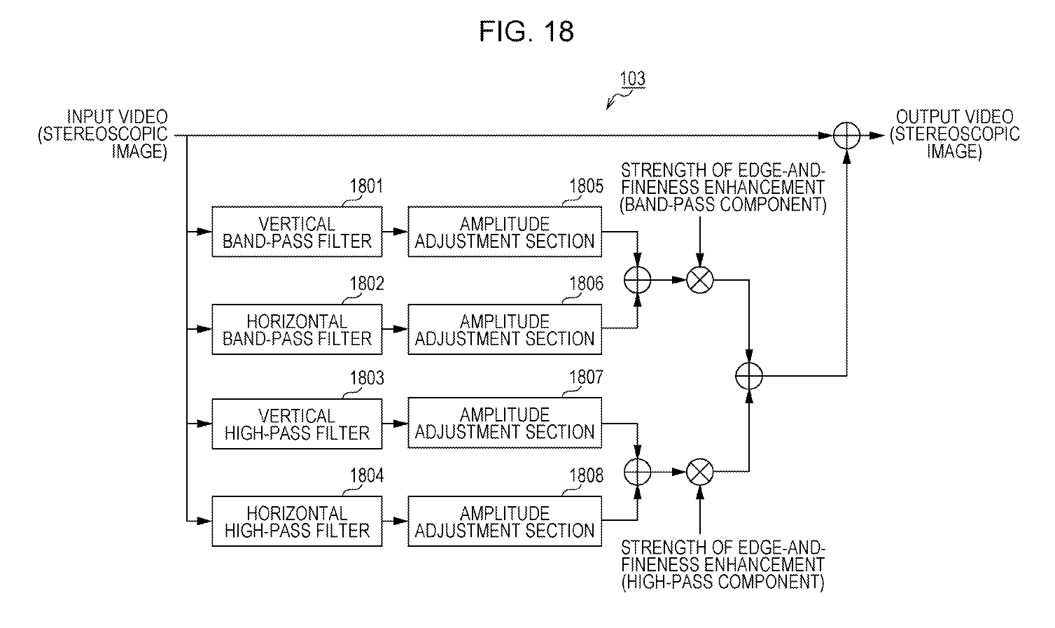

FIG. 18 illustrates an example of an internal configuration of the edge-and-fineness enhancement processing section 103.

A vertical band-pass filter 1801 extracts a band-pass component in the vertical direction of the stereoscopic image, and a subsequent-stage amplitude adjustment section 1805 adjusts an amplitude of the extracted band-pass component in the vertical direction. Also, a horizontal band-pass filter 1802 extracts a band-pass component in the horizontal direction of the stereoscopic image, and a subsequent-stage amplitude adjustment section 1806 adjusts an amplitude of the extracted band-pass component in the horizontal direction. The band-pass component in the vertical direction, which has been subjected to the amplitude adjustment, and the band-pass component in the horizontal direction are added. Further, the strength of the edge-and-fineness enhancement obtained by the depth calculation in accordance with the processing in FIG. 16 is given to the band-pass component.

A vertical high-pass filter 1803 extracts a high-pass component in the vertical direction of the stereoscopic image, and a subsequent-stage amplitude adjustment section 1807 adjusts an amplitude of the high-pass component of the extracted vertical direction. Also, a horizontal high-pass section 1804 extracts a high-pass component in the horizontal direction of the stereoscopic image, and a subsequent-stage amplitude adjustment section 1808 adjusts an amplitude in horizontal direction of the high-pass component. The high-pass component in the vertical direction, which has been subjected to the amplitude adjustment, and the high-pass component in the horizontal direction are added. Further, the strength of the edge-and-fineness enhancement obtained by the depth calculation in accordance with the processing in FIG. 16 is given to the high-pass component.

And the band-pass component and the high-pass component whose strength are given by the strength of the edge-and-fineness enhancement obtained by the depth calculation are added, and this result is added to the input signal.

In short, the video signal processing apparatus 100 according to the technique disclosed in this specification is configured to change the strength of the edge-and-fineness enhancement in accordance with a focus position and a depth of field of a stereoscopic image as illustrated in FIG. 2A.

Also, it can be said that, as illustrated in FIG. 2B, the video signal processing apparatus 100 is configured to change the strength of the edge-and-fineness enhancement in accordance with the amount of depth of a stereoscopic image.

Also, it can be said that, as illustrated in FIG. 12, the video signal processing apparatus 100 is configured to separate an amount of depth for each block into a near view and a distant view, and as illustrated in FIG. 14, and to calculate the strength of the edge-and-fineness enhancement from a difference between the amount of depth of the near view and the amount of depth of the distant view.

Also, it can be said that, as illustrated in FIG. 12, the video signal processing apparatus 100 is configured to separate an amount of depth for each block into a near view and a distant view, and as illustrated in FIG. 15, and to calculate strength of the edge-and-fineness enhancement from a difference between the band component of the near view and the band component of the distant view.

Also, it can be said that the video signal processing apparatus 100 is configured to perform matching on the left-eye image and the right-eye image for each block at the time of calculating the amount of depth, and as illustrated in FIG. 9B, to make a block size of the left-eye image smaller than a block size of the right-eye image so as to simplify searching of a feature point.

In this regard, the technique disclosed in this specification can be configured as follows.

(1) A video signal processing apparatus including: a video input section configured to receive input of a stereoscopic image; a depth calculation section configured to perform depth calculation of the input stereoscopic image; and an edge-and-fineness enhancement processing section configured to perform image quality adjustment with varied strength of edge-and-fineness enhancement of the stereoscopic image on the basis of a result of the depth calculation by the depth calculation section.

(2) The video signal processing apparatus according to (1), wherein the edge-and-fineness enhancement processing section determines the strength of the edge-and-fineness enhancement on the basis of a focus position determined from the result of the depth calculation by the depth calculation section.

(3) The video signal processing apparatus according to (1), wherein if a near-view portion of the stereoscopic image is determined to be in focus as the result of the depth calculation by the depth calculation section, the edge-and-fineness enhancement processing section increases the strength of the edge-and-fineness enhancement, else if a distant-view portion of the stereoscopic image is determined to be in focus as the result of the depth calculation, the edge-and-fineness enhancement processing section decreases the strength of the edge-and-fineness enhancement, and if the stereoscopic image is determined to have a deep depth of field as the result of the depth calculation, the edge-and-fineness enhancement processing section slightly decreases the strength of the edge-and-fineness enhancement.

(4) The video signal processing apparatus according to (1), wherein if a difference in amount of depth between a near view and a distant view of the stereoscopic image is determined to be large as the result of the depth calculation by the depth calculation section, the edge-and-fineness enhancement processing section increases the strength of the edge-and-fineness enhancement, and if a difference in amount of depth between a near view and a distant view of the stereoscopic image is determined to be small as the result of the depth calculation, the edge-and-fineness enhancement processing section decreases the strength of the edge-and-fineness enhancement.

(5) The video signal processing apparatus according to (1), wherein the edge-and-fineness enhancement processing section performs the edge-and-fineness enhancement with uniform strength on an overall image of one frame.

(6) The video signal processing apparatus according to (1), wherein the video input section receives input of the stereoscopic image in a method of multiplexing simultaneous left-eye image and right-eye image in a time direction, and the depth calculation section extracts a feature quantity from a left-eye image, then extracts a feature quantity from a simultaneous right-eye image, and compares the feature quantity of the left-eye image and the feature quantity of the right-eye image so as to calculate a depth of the stereoscopic image.

(7) The video signal processing apparatus according to (6), wherein the depth calculation section performs band-pass filter processing with a predetermined number of taps on the left-eye image in the vertical direction and in the horizontal direction individually, obtains a feature quantity of each pixel position on the basis of a product of a band-pass component in the vertical direction and a band-pass component in the horizontal direction, detects a pixel position having a maximum feature quantity in each block as a feature point, stores a feature quantity of the feature point of each block, calculates a same feature quantity as described above at all the pixel positions of each block of the right-eye image, compares the calculated feature quantity with the feature quantity stored at the feature point of the corresponding block to the left-eye image, detects a pixel position of the right-eye image matching the feature point of the left-eye image for each block, and stores an amount of depth and a band component at a pixel position of the right-eye image matching the feature point of the left-eye image for each block.

(8) The video signal processing apparatus according to (6), wherein the depth calculation section stores, for a feature point of each block of the left-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block, and an x-coordinate of the feature point in the block as feature-point data, calculates, at all the pixel positions of each block of the right-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block as feature-point data, takes a weighted sum of absolute difference between the feature-point data at each pixel position and the feature-point data at the corresponding feature point of the left-eye image as an evaluation value of each pixel position, obtains a pixel position having a minimum evaluation value in each block of the right-eye image as a pixel position matching the feature point of the left-eye image, and stores an amount of depth and a band component at the pixel position of the right-eye image matching the feature point of the left-eye image in each block.

(9) The video signal processing apparatus according to (7) or (8), wherein the depth calculation section classifies each block into a near view and a distant view on the basis of the amount of depth, averages amounts of depth and band components of blocks in the near view, and averages amounts of depth and band components of blocks in the distant view.

(10) The video signal processing apparatus according to (9), wherein the depth calculation section obtains a difference between the amounts of depth of the near view and the distant view of the stereoscopic image by calculating a difference between the mean value of the amounts of depth in the near view block and the mean value of the amounts of depth in the distant view block, if the difference between the amounts of depth of the near view and the distant view of the stereoscopic image is large, a weight for the strength of the edge-and-fineness enhancement is increased, and if the difference between the amounts of depth of the near view and the distant view of the stereoscopic image is small, a weight for the strength of the edge-and-fineness enhancement is decreased.

(11) The video signal processing apparatus according to (9), wherein the depth calculation section obtains a difference between band components of the near view and the distant view of the stereoscopic image by calculating a difference between the mean value of the band components in the near view block and the mean value of the band components in the distant view block, if the difference between the band components of the near view and the distant view of the stereoscopic image is large, a weight for the strength of the edge-and-fineness enhancement is increased, and if the difference between the band components of the near view and the distant view of the stereoscopic image is small, a weight for a strength of the edge-and-fineness enhancement is decreased.

(12) The video signal processing apparatus according to (9), wherein the depth calculation section combines a weight given on the basis of the averaged amount of depth and a weight given on the basis of the averaged band component, and then performs low-pass filter processing to obtain the strength of the edge-and-fineness enhancement.

(13) The video signal processing apparatus according to (12), further including an interframe movement detection section configured to detect interframe movement of the input image, wherein if the interframe movement is large, the depth calculation section performs the low-pass filter processing with a filter coefficient having a small time constant, and if the interframe movement is small, the depth calculation section performs the low-pass filter processing with a filter coefficient having a large time constant.

(14) The video signal processing apparatus according to (7) or (8), wherein a block size of the left-eye image is made smaller than a block size of the left-eye image.

(15) A method of processing a video signal, including: receiving input of a stereoscopic image; performing depth calculation of the input stereoscopic image; and processing edge-and-fineness enhancement to perform image quality adjustment with varied strength of the edge-and-fineness enhancement of the stereoscopic image on the basis of a result of the depth calculation by the performing depth calculation.

(16) A computer program, described in a computer-readable format, for causing a computer to perform functions including: a video input section configured to receive input of a stereoscopic image; a depth calculation section configured to perform depth calculation of the input stereoscopic image; and an edge-and-fineness enhancement processing section configured to perform image quality adjustment with varied strength of edge-and-fineness enhancement of the stereoscopic image on the basis of a result of the depth calculation by the depth calculation section.

In the above, a detailed description has been given of the technique disclosed in this specification with reference to a specific embodiment. However, it is obvious to those skilled in the art that modifications and alterations of the embodiment are possible without departing from the spirit and scope of the technique disclosed in this specification.

The edge-and-fineness enhancement processing in the embodiment described in this specification can be performed either by hardware or by software. When the processing is executed by software, a computer program describing a processing procedure in a computer-readable format ought to be installed in a predetermined computer, and ought to be executed.

In short, the present technique has been disclosed as an example, and it is to be understood that the description of this specification is not construed in a limited manner. In order to understand the gist of this technique, the scope of the appended claims should be considered.

The present disclosure contains subject matter related to that disclosed in Japanese Priority Patent Application JP 2011-180171 filed in the Japan Patent Office on Aug. 22, 2011, the entire contents of which are hereby incorporated by reference.

What is claimed is:

1. A video signal processing apparatus comprising:
a video input section configured to receive input of a stereoscopic image;
a depth calculation section configured to perform depth calculation of the input stereoscopic image; and
an edge-and-fineness enhancement processing section configured to perform image quality adjustment with varied strength of edge-and-fineness enhancement of the stereoscopic image on the basis of a result of the depth calculation by the depth calculation section.

2. The video signal processing apparatus according to claim 1,
wherein the edge-and-fineness enhancement processing section determines the strength of the edge-and-fineness enhancement on the basis of a focus position determined from the result of the depth calculation by the depth calculation section.

3. The video signal processing apparatus according to claim 1,
wherein if a near-view portion of the stereoscopic image is determined to be in focus as the result of the depth calculation by the depth calculation section, the edge-and-fineness enhancement processing section increases the strength of the edge-and-fineness enhancement, else if a distant-view portion of the stereoscopic image is determined to be in focus as the result of the depth calculation, the edge-and-fineness enhancement processing section decreases the strength of the edge-and-fineness enhancement, and if the stereoscopic image is determined to have a deep depth of field as the result of the depth calculation, the edge-and-fineness enhancement processing section slightly decreases the strength of the edge-and-fineness enhancement.

4. The video signal processing apparatus according to claim 1,
wherein if a difference in amount of depth between a near view and a distant view of the stereoscopic image is determined to be large as the result of the depth calculation by the depth calculation section, the edge-and-fineness enhancement processing section increases the strength of the edge-and-fineness enhancement, and if a difference in amount of depth between a near view and a distant view of the stereoscopic image is determined to be small as the result of the depth calculation, the edge-and-fineness enhancement processing section decreases the strength of the edge-and-fineness enhancement.

5. The video signal processing apparatus according to claim 1,
wherein the edge-and-fineness enhancement processing section performs the edge-and-fineness enhancement with uniform strength on an overall image of one frame.

6. The video signal processing apparatus according to claim 1,
wherein the video input section receives input of the stereoscopic image in a method of multiplexing simultaneous left-eye image and right-eye image in a time direction, and
the depth calculation section extracts a feature quantity from a left-eye image, then extracts a feature quantity from a simultaneous right-eye image, and compares the feature quantity of the left-eye image and the feature quantity of the right-eye image so as to calculate a depth of the stereoscopic image.

7. The video signal processing apparatus according to claim 6,
wherein the depth calculation section performs band-pass filter processing with a predetermined number of taps on the left-eye image in the vertical direction and in the horizontal direction individually, obtains a feature quantity of each pixel position on the basis of a product of a band-pass component in the vertical direction and a band-pass component in the horizontal direction, detects a pixel position having a maximum feature quantity in each block as a feature point, stores a feature quantity of the feature point of each block,
calculates a same feature quantity as described above at all the pixel positions of each block of the right-eye image, compares the calculated feature quantity with the feature quantity stored at the feature point of the corresponding block to the left-eye image, detects a pixel position of the right-eye image matching the feature point of the left-eye image for each block, and
stores an amount of depth and a band component at a pixel position of the right-eye image matching the feature point of the left-eye image for each block.

8. The video signal processing apparatus according to claim 6,
wherein the depth calculation section stores, for a feature point of each block of the left-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block, and an x-coordinate of the feature point in the block as feature-point data,
calculates, at all the pixel positions of each block of the right-eye image, a band-pass component in the vertical direction, a band-pass component in the horizontal direction, a mean value of an upper-left pixel, a mean value of an upper-right pixel, a mean value of a lower-left pixel, a mean value of a lower-right pixel, a y-coordinate of the feature point in the block as feature-point data, takes a weighted sum of absolute difference between the feature-point data at each pixel position and the feature-point data at the corresponding feature point of the left-eye image as an evaluation value of each pixel position,
obtains a pixel position having a minimum evaluation value in each block of the right-eye image as a pixel position matching the feature point of the left-eye image, and
stores an amount of depth and a band component at the pixel position of the right-eye image matching the feature point of the left-eye image in each block.

9. The video signal processing apparatus according to claim 7,
wherein the depth calculation section classifies each block into a near view and a distant view on the basis of the amount of depth, averages amounts of depth and band components of blocks in the near view, and averages amounts of depth and band components of blocks in the distant view.

10. The video signal processing apparatus according to claim 9,
wherein the depth calculation section obtains a difference between the amounts of depth of the near view and the distant view of the stereoscopic image by calculating a difference between the mean value of the amounts of depth in the near view block and the mean value of the amounts of depth in the distant view block,
if the difference between the amounts of depth of the near view and the distant view of the stereoscopic image is large, a weight for the strength of the edge-and-fineness enhancement is increased, and if the difference between the amounts of depth of the near view and the distant view of the stereoscopic image is small, a weight for the strength of the edge-and-fineness enhancement is decreased.

11. The video signal processing apparatus according to claim 9,
wherein the depth calculation section obtains a difference between band components of the near view and the distant view of the stereoscopic image by calculating a difference between the mean value of the band components in the near view block and the mean value of the band components in the distant view block,
if the difference between the band components of the near view and the distant view of the stereoscopic image is large, a weight for the strength of the edge-and-fineness enhancement is increased, and if the difference between the band components of the near view and the distant view of the stereoscopic image is small, a weight for the strength of the edge-and-fineness enhancement is decreased.

12. The video signal processing apparatus according to claim 9,
wherein the depth calculation section combines a weight given on the basis of the averaged amount of depth and a weight given on the basis of the averaged band component, and then performs low-pass filter processing to obtain the strength of the edge-and-fineness enhancement.

13. The video signal processing apparatus according to claim 12, further comprising an interframe movement detection section configured to detect interframe movement of the input image,
wherein if the interframe movement is large, the depth calculation section performs the low-pass filter processing with a filter coefficient having a small time constant, and if the interframe movement is small, the depth calculation section performs the low-pass filter processing with a filter coefficient having a large time constant.

14. The video signal processing apparatus according to claim 7,
wherein a block size of the left-eye image is made smaller than a block size of the left-eye image.

15. A method of processing a video signal, comprising:
receiving input of a stereoscopic image;
performing depth calculation of the input stereoscopic image; and
processing edge-and-fineness enhancement to perform image quality adjustment with varied strength of the edge-and-fineness enhancement of the stereoscopic image on the basis of a result of the depth calculation by the performing depth calculation.

16. A computer program, described in a computer-readable format, for causing a computer to perform functions comprising:
a video input section configured to receive input of a stereoscopic image;
a depth calculation section configured to perform depth calculation of the input stereoscopic image; and
an edge-and-fineness enhancement processing section configured to perform image quality adjustment with varied strength of edge-and-fineness enhancement of the stereoscopic image on the basis of a result of the depth calculation by the depth calculation section.
